(19) United States
(12) Patent Application Publication
(10) Pub. No.: US 2005/0248250 A1
(43) Pub. Date: Nov. 10, 2005

(54) Cathode structure for explosive electron emission and method of forming the same

(75) Inventors: Sergey A. Korenev, Mundelein, IL (US); Ivan S. Korenev, Mundelein, IL (US)

Correspondence Address: KUSNER & JAFFE;HIGHLAND PLACE SUITE 310, 6151 WILSON MILLS ROAD, HIGHLAND HEIGHTS, OH, 44143, US

(73) Assignee: STERIS Inc

(21) Appl. No.: 10/840,871

(22) Filed: May 7, 2004

(51) Int. Cl. H01J 1/00

(52) U.S. Cl. 313/311; 313/346 R

(57) ABSTRACT

An emission cathode having a surface formed of carbon fiber and a layer of carbon nanotubes attached to the surface. The carbon nanotubes are generally parallel to each other and oriented longitudinally in a predetermined direction relative to the surface.

### FIELD OF THE INVENTION

The present invention relates to a cathode structure, and more particularly, to a cathode structure for producing explosive electron emissions, and a method of forming the same.

### BACKGROUND OF THE INVENTION

Explosive electron emission is a specific emission phenomenon that is observed when a field electron emitter, i.e., a cathode, explodes due to extreme emission current density. Under these conditions, a quasi-steady-state phase transition occurs as the condensed cathode material explodes to form a dense plasma. This phase transition emits an intensive flow of electrons when in a vacuum. Following initiation of the localized explosive electron emission events, the emitting area rapidly expands over the cathode surface, as a result of plasma spreading, thus insuring maintenance of the emission process and involvement in the process of macroscopic surface areas.

Plasma generated in a vacuum gap between the cathode and an anode determines the current-voltage characteristics of a diode. The explosive electron emission produces a current density close to the maximum obtainable field emission current density, and very high values of the total current in the beam (10²-10⁶ A). Cathode assemblies that exhibit explosive emission have a wide range of applications.

One material that finds advantageous application in explosive emission cathodes is carbon, and more particularly, carbon fibers. In this respect, carbon is conductive and has good emission characteristics. Carbon fiber cathodes exhibit stable current yields at voltages ranging from 100 kV to 500 kV. However, at lower voltages, a screening effect of the electrical field on the surface of the cathode leads to dissipation of the energy of the cathode plasma that results in vacuum discharge in only a few, specific places on the surface of the cathode.

The present invention overcomes this and other problems, and provides an explosive emission cathode comprised of carbon fibers and carbon nanotubes, and further provides a method of forming the same.

### SUMMARY OF THE INVENTION

In accordance with a preferred embodiment of the present invention, there is provided an emission cathode, comprised of a cathode body that has a surface portion formed of carbon fibers. A polymer coating is provided on the surface portion, and carbon nanotubes are embedded in the polymeric coating. Substantially all of the nanotubes are longitudinally oriented in substantially the same direction.

In accordance with another aspect of the present invention, there is provided an emission cathode that has a surface formed of carbon fiber. A layer of carbon nanotubes is attached to the surface. The carbon nanotubes are generally parallel to each other and oriented longitudinally in a predetermined direction relative to the surface.

In accordance with another aspect of the present invention, there is provided a cathode that has a body portion formed of carbon fibers. The body has a surface coated with a layer comprised of carbon nanotubes embedded in a polymer matrix. Substantially all of the nanotubes are longitudinally aligned in substantially the same direction.

In accordance with yet another aspect of the present invention, there is provided a method of forming an explosive emission cathode, comprising the steps of forming a cathode body that has a planar surface formed of carbon fibers, coating the planar surface with an uncured polymer, adhering carbon nanotubes onto the uncured polymer on the planar surface, exposing the carbon nanotubes to an electric field to longitudinally align the nanotubes relative to the electric field, and curing the uncured polymer.

In accordance with still another aspect of the present invention, there is provided a method of forming an explosive emission cathode, comprised of:
(a) applying carbon nanotubes onto a surface of a body formed of carbon fibers;
(b) longitudinally orienting the carbon nanotubes in a predetermined direction; and
(c) securing the oriented carbon nanotubes onto the surface of the carbon fiber body by means of a polymer.

In accordance with another aspect of the present invention, there is provided a method of forming an emission cathode, comprised of:
(a) forming a cathode body having a surface portion formed of carbon fibers; and
(b) securing a plurality of carbon nanotubes onto the surface portion, wherein the nanotubes are essentially parallel to each other and aligned longitudinally in a predetermined direction.

An advantage of the present invention is an explosive electron emission cathode.

Another advantage of the present invention is an explosive electron emission cathode formed of carbon fibers or carbon nanotubes.

Another advantage of the present invention is an explosive electron emission cathode that exhibits stable beam current and voltages between 2 kV and 50 kV.

A still further advantage of the present invention is an explosive electron emission cathode as described above that has a longer use life than an explosive electron emission cathode known heretofore.

Another advantage of the present invention is a method of forming an explosive emission cathode of the type heretofore described.

These and other advantages will become apparent from the following description of a preferred embodiment taken together with the accompanying drawings and the appended claims.

### BRIEF DESCRIPTION OF THE DRAWINGS

The invention may take physical form in certain parts and arrangement of parts, a preferred embodiment of which will be described in detail in the specification and illustrated in the accompanying drawings which form a part hereof, and wherein:

FIG. 1 is a schematic view of a diode assembly showing a cathode according to the present invention mounted within a vacuum chamber;

FIG. 2 is an enlarged, sectional view of area 2 of FIG. 1;

FIGS. 3A-3D are views illustrating various steps in forming an explosive electron emission cathode as shown in FIG. 1;

FIGS. 4A-4C are enlarged, partial views showing the explosive electron emission cathode at various stages of construction;

FIGS. 5A-5D are views illustrating various steps in forming a planar explosive electron emission cathode, illustrating another embodiment of the present invention;

FIGS. 6A-6C are enlarged, partial views showing the explosive electron emission cathode shown in FIGS. 5A-5D at various stages of construction; and

FIG. 7 is a graph showing the voltage-current characteristics for a carbon fiber and carbon nanotube cathode according to the present invention and a carbon fiber cathode formed without carbon nanotubes.

### DETAILED DESCRIPTION OF PREFERRED EMBODIMENT

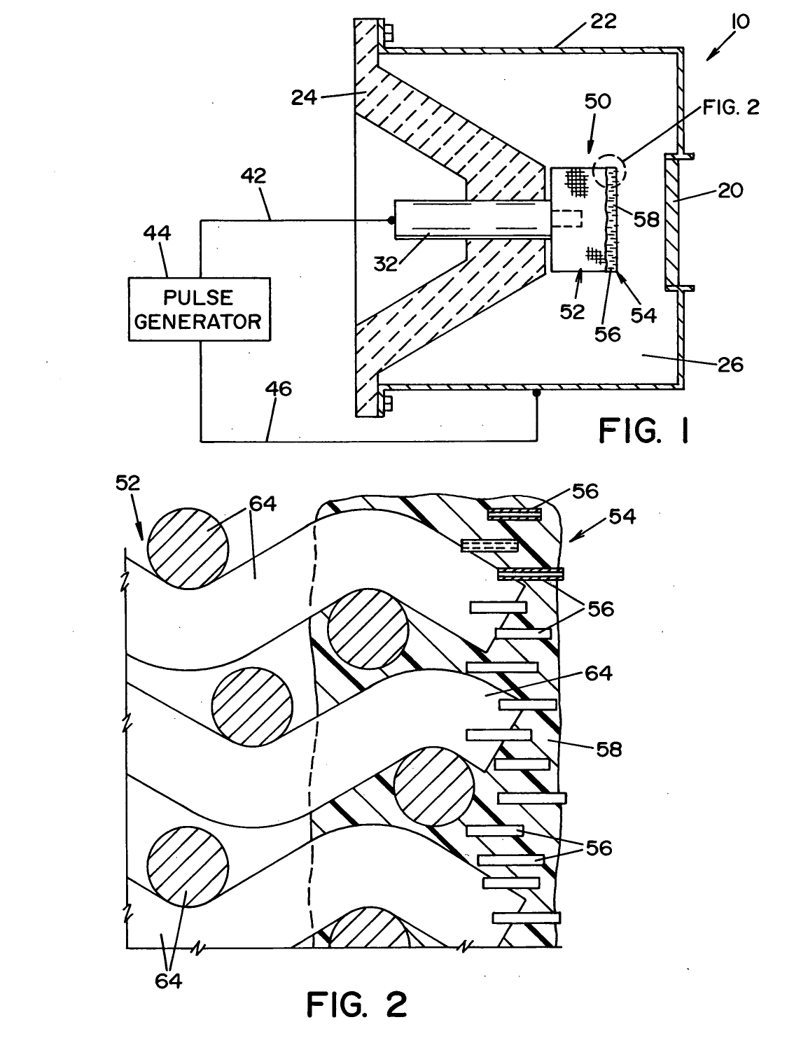

Referring now to the drawings wherein the showings are for the purpose of illustrating preferred embodiments of the invention only, and not for the purpose of limiting same, FIG. 1 shows a diode structure 10 comprised of an anode 20 and an explosive emission cathode 50. Cathode 50 illustrates a preferred embodiment of the present invention. Cathode 50 is disposed within a housing 22 that is attached to an insulator 24. Housing 22 and insulator 24 define a sealed chamber 26 in which a vacuum can be established, by conventional means not shown. Insulator 24 is adapted to hold an elongated electrode 32. In the embodiment shown, electrode 32 is cylindrical in shape. A first lead 42 from a pulse generator 44 is attached to one end of electrode 32. A second lead 46 from pulse generator 44 is attached to housing 22. Explosive electron emission cathode 50 is attached to the other end of electrode 32. Cathode 50 is disposed within vacuum chamber 26 opposite anode 20. Anode 20 is disposed in an opening in housing 22.

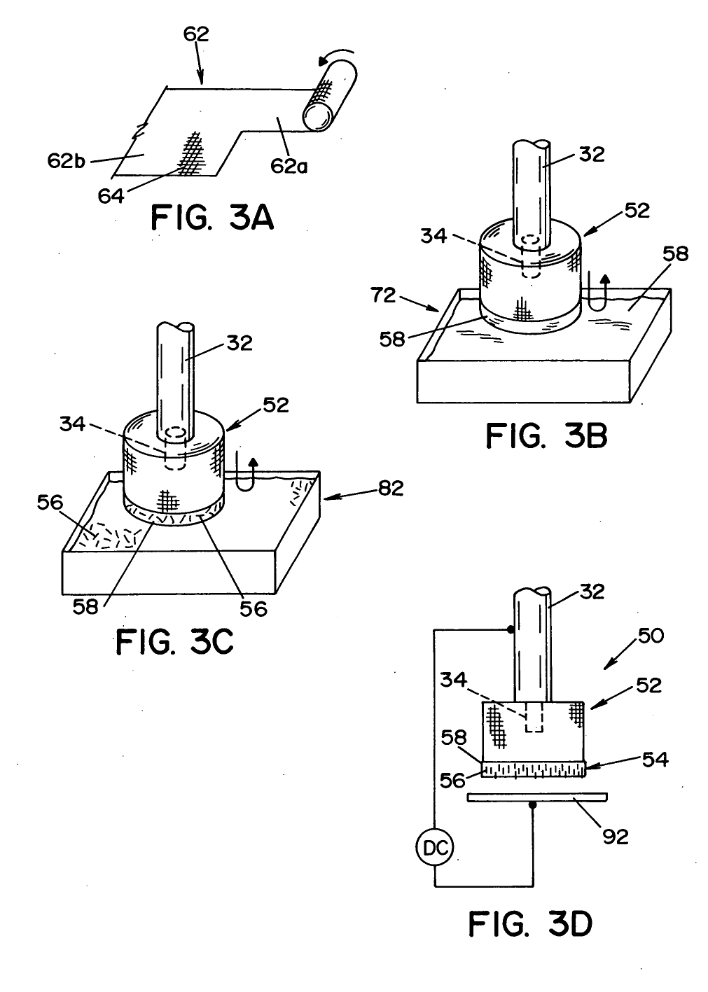

Cathode 50 is generally comprised of a main body portion 52 formed from carbon fiber, and a surface portion 54 formed of carbon nanotubes 56 embedded in a polymer matrix 58 (see FIG. 2). In accordance with one aspect of the present invention, carbon nanotubes 56 are oriented generally parallel to each other, so as to be aligned longitudinally in a predetermined direction. In the embodiment shown, nanotubes 56 are aligned longitudinally toward anode 20. In other words, nanotubes 56 are generally disposed parallel to each other and axially aligned in a direction toward anode 20. In the embodiment shown, such alignment would place nanotubes 56 in an orientation perpendicular to the end surface of body portion 52 of cathode 50.

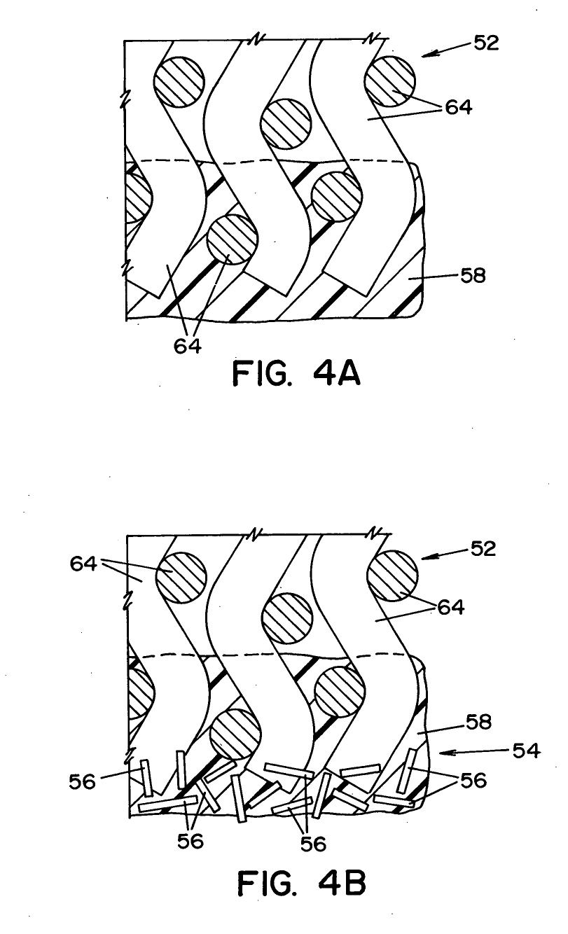

In the embodiment shown, body portion 52 of cathode 50 is comprised of a tightly wound roll of a carbon-fiber cloth. Body portion 52 of cathode 50 is generally cylindrical in shape, as best illustrated in FIGS. 3B and 3C. As indicated above, cylindrical body portion 52 is attached to one end of electrode 32. In the embodiment shown, electrode 32 has a cylindrical shank or pin 34 formed at one end thereof. Cylindrical body portion 52 of cathode 50 includes a cylindrical bore that is formed in one end. The cylindrical bore in body section 52 is dimensioned to receive shank 34 at the end of electrode 32, as best seen in FIGS. 3B-3C. The cylindrical bore in body section 52 may also be formed by machining after body section 52 has been formed. In the embodiment shown, the cylindrical bore in body portion 52 is formed by rolling a strip 62 of carbon-fiber cloth having two (2) longitudinal sections 62a, 62b of different widths, as best illustrated in FIG. 3A. As illustrated in FIG. 3A, narrow section 62a is rolled first, thereby forming the inner core of body portion 52. As wider section 62b of strip 62 is rolled onto the core formed by section 62a, a hole or bore is formed in body section 52 due to the different width of section 62a, 62b of strip 62. Insertion of shank 34 into the bore in body portion 52 facilitates good electrical surface contact between electrode 32 and cathode body portion 52. Body portion 52 of cathode 50 may be secured to electrode 32 by conventional fasteners, such as bands or metal screws.

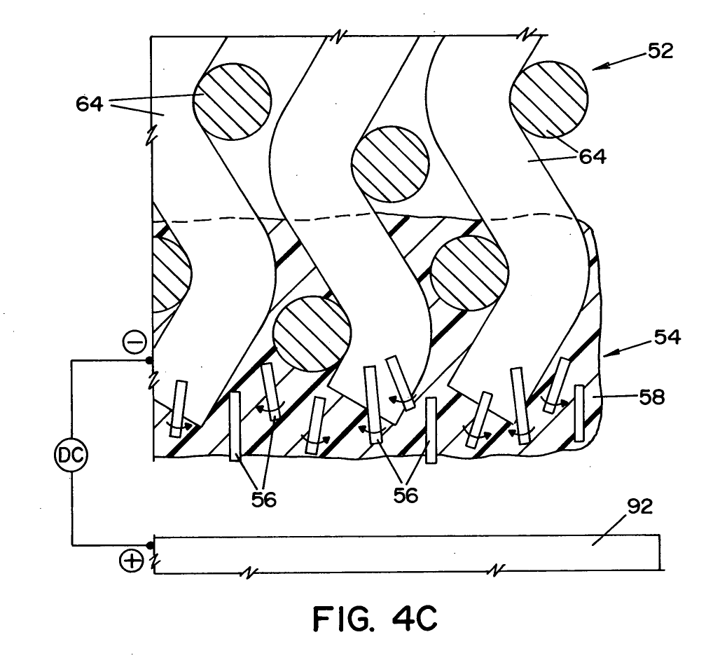

With body portion 52 of cathode 50 attached to electrode 32, the exposed face of body portion 52 is dipped into a bath 72 of an uncured polymer 58, as pictorially illustrated in FIG. 3B. In one embodiment, polymer 58 is a thermoset. In one embodiment, polymer 58 is an epoxy resin. In another embodiment, polymer 58 is a urethane polymer. In another embodiment, polymer 58 is a solvated thermoplastic. The exposed end of body portion 52 is dipped into the resin to a predetermined depth for a predetermined period of time sufficient to allow the resin to penetrate into the woven, carbon fiber cloth, as pictorially illustrated in FIG. 4A. In FIG. 4A, the carbon fibers of carbon fiber cloth 62 that form cathode body portion 52 are designated “64,” and the resin layer on the end of cathode body portion 52 is designated “58.” The liquid resin basically forms a coating over the planar, free end of body portion 52.

The coated end of body portion 52 of cathode 50 is then dipped into a tray or bath 82 of carbon nanotubes 56, as illustrated in FIG. 3C. Since nanotubes 56 are microscopic in size, nanotubes 56 exhibit fluid-like properties within tray 82. In one embodiment, nanotubes 56 are disposed in a stream of gas thus forming a fluidized bed of nanotubes 56. A layer of nanotubes 56 will adhere to the polymer on the face of body portion 52, as pictorially illustrated in FIG. 4B. As illustrated in FIG. 4B, nanotubes 56 that become embedded and attached to polymer 58 are oriented randomly.

Body portion 52 with nanotubes 56 embedded in the resin layer is then placed in an electric field. The electric field is preferably created by placing a metal plate 92 adjacent to, but spaced from, the coated surface of body portion 52 of cathode 50, as illustrated in FIG. 3D. A DC current is then applied to electrode 32 that is attached to cathode 50 and to metal plate 92 facing the resin and nanotubes-coated surface of cathode body 52. In the presence of an electrical field, nanotubes 56 become electrically polarized and rotate to align themselves parallel to the electrical field. FIG. 4C illustrates the alignment of nanotubes 56 relative to the electrical field that is established between cathode body 52 and metal plate 92. The electrical field is maintained across cathode 50 and plate 92 until polymer 58 is either cured or hardens as the solvent (in the case of a solvated thermoplastic) evaporates, thereby locking nanotubes 56 in their aligned position, wherein nanotubes 56 are essentially parallel to each other with their long axis aligned in the direction of the electrical field. In the embodiment shown, the long axis of nanotubes 56 extends generally perpendicular to the planar end surface of the cylindrical cathode body 52.

As pictorially illustrated in FIG. 2, some of nanotubes 56 will be totally embedded within the coating of polymer 58, while other nanotubes 56 will extend slightly beyond the surface of polymer 58. Depending upon the nature of polymer 58, conventional curing mechanisms, i.e., for thermosetting polymers, such as heat, ultraviolet (UV) light and chemicals may be used to cure polymer 58.

The present invention shall be further described by means of the following Example.

### EXAMPLE

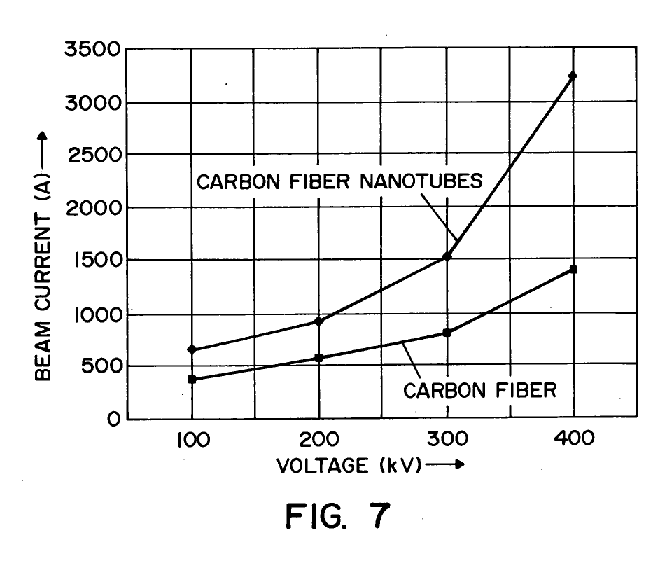

Two carbon fiber cathodes are formed using woven carbon fabric. Woven carbon fabric manufactured by J. D. Lincoln Inc. of Costa Mesa, Calif., under the Product Nos. L-901 through L-996, find advantageous application in forming the carbon fiber cathode. A cylindrical carbon cathode is formed on an electrode, as generally described above. Carbon nanotubes are applied to the face of one carbon electrode as described above. Single-wall carbon nanotubes are used. Nanotubes are available from Carbon Nanotechnologies Inc. of Houston, Tex. An electron beam (e-beam) curable resin sold under the trade name Tactix 123 is used to secure the nanotubes to the face of the carbon fiber cathode. The two (2) cathodes are then tested in a vacuum. FIG. 7 is a graph showing the voltage to beam current characteristics of the respective cathodes. As illustrated in FIG. 7, the carbon fiber cathode that has nanotubes along the operational surface thereof exhibits substantially higher beam currents for essentially the same applied voltages.

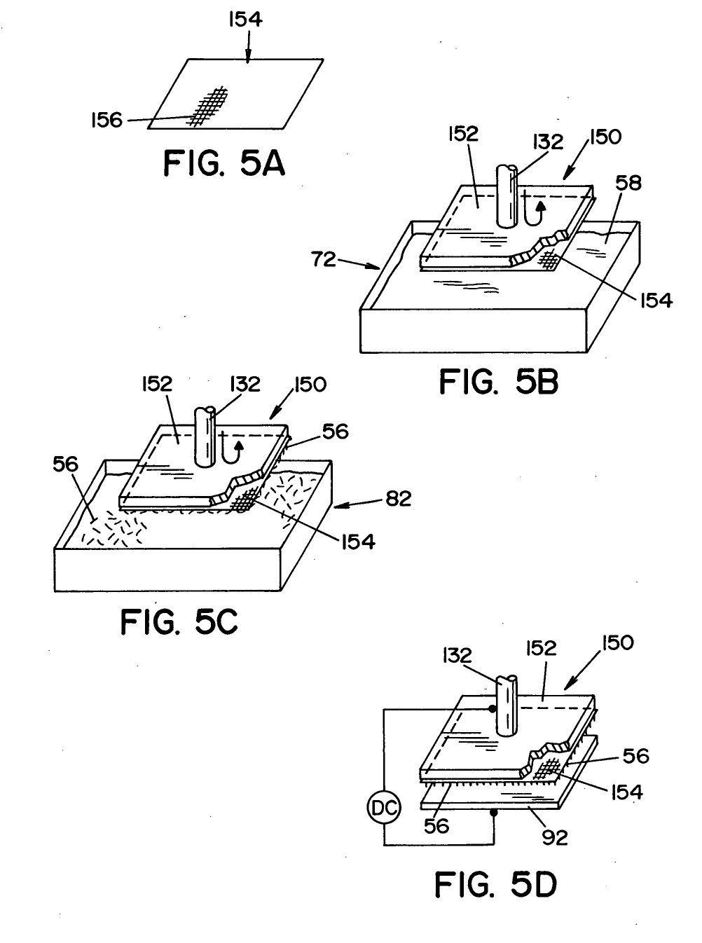

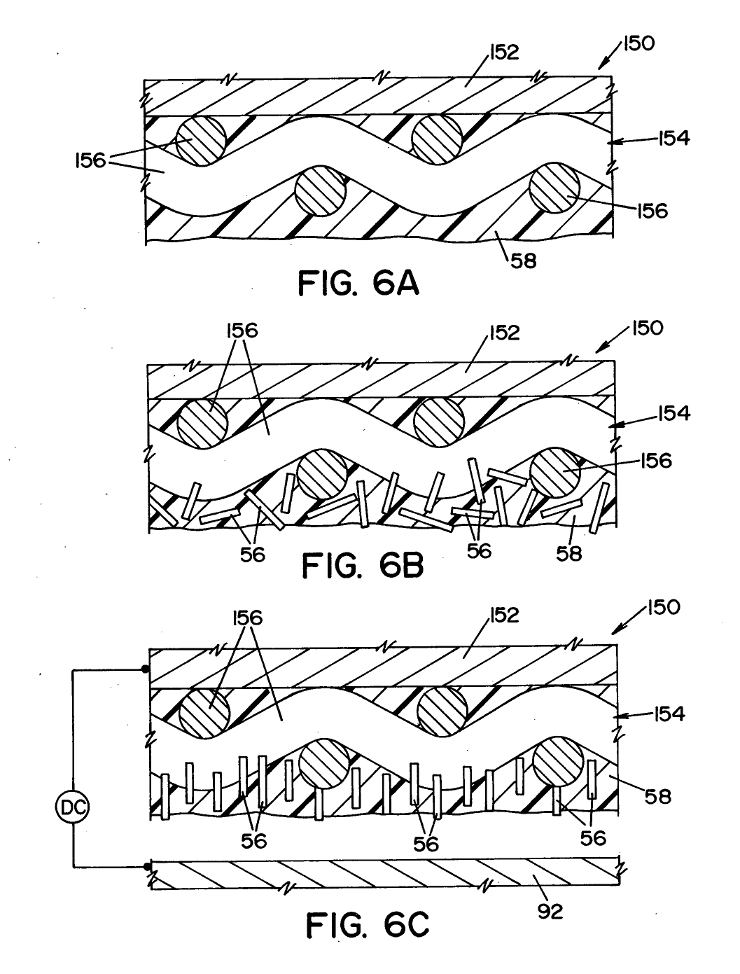

Referring now to FIGS. 5A through 6C, an explosive emission cathode 150, illustrating another embodiment of the present invention, is shown. Cathode 150 is comprised of a metallic substrate 152 having a layer 154 of carbon fiber cloth overlying and attached to one (1) surface thereof. Layer 154 may be attached to metallic substrate 152 by a number of different, conventional means, such as bands or mechanical fasteners. A metallic electrode 132 is fixedly attached to metallic substrate 152. Electrode 132 is attached to substrate 152 in a manner providing a good electrically-conductive connection therebetween. Layer 154 of carbon fiber cloth is dipped or immersed in bath 72 containing uncured polymer 58, as in the prior embodiment, and as illustrated in FIG. 5B. Cathode 150 is immersed for a sufficient amount of time to allow the uncured polymer 58 to penetrate into layer 154 of the carbon-fiber cloth, as pictorially illustrated in FIG. 6A. In FIGS. 6A-6C, carbon fibers forming sheet 154 are designated 156, and the polymer is designated 58, as in the prior embodiment. Cathode 150 is then dipped into a tray, bath or fluidized bed 82 of nanotubes 56, as described above, to collect a layer of nanotubes 56 on the uncured polymer 58, as illustrated in FIG. 5C. FIG. 6B pictorially illustrates the surface of cathode 150 after nanotubes 56 are applied thereto, and illustrates the random orientation of nanotubes 56 embedded within the uncured polymer 58. Cathode 150 is then exposed to an electrical field, as illustrated in FIG. 5D. The electrical field is created by placing a plate 92 parallel to cathode 150 and energizing cathode 150 and plate 92 with DC current to form an electric field therebetween. As in the prior embodiment, the resulting electrical field aligns carbon nanotubes 56 such that the long axis of nanotubes 56 are essentially parallel to each other and aligned longitudinally in the direction toward anode plate 92. FIG. 6C shows the surface of cathode 150 adjacent plate 92, and pictorially illustrates nanotubes 56 being aligned in the electrical field relative to plate 92.

A cathode 50, 150 as described above provides a more homogenous cathode surface having a greater number of locations per electrical discharge as compared to the much larger carbon fibers. Nanotubes 56, and the longitudinal alignment of nanotubes 56, provide a greater number of distinct, isolated locations for plasma generation, as compared to much larger carbon fibers. As a result, emissions at much lower voltages, in the range of 2 to 50 kV, provide stable parameters of beam current. Moreover, it is believed that the lifetime of cathodes 50, 150 for voltages up to 100 kV can approach approximately 10⁸ cycles. The present invention thus provides an explosive electron emission cathode surface having a significantly greater number of distinct emitter locations, as compared to a cathode comprised of carbon fibers. The much greater number of carbon nanotubes 56 along the cathode surface requires less surface energy for emission. By aligning nanotubes 56 according to the method discussed above, the emitter ends of nanotubes 56 are spaced apart and provide distinct emitter locations from adjacent nanotubes 56.

The foregoing description is a specific embodiment of the present invention. It should be appreciated that this embodiment is described for purposes of illustration only, and that numerous alterations and modifications may be practiced by those skilled in the art without departing from the spirit and scope of the invention. It is intended that all such modifications and alterations be included insofar as they come within the scope of the invention as claimed or the equivalents thereof.

1. An emission cathode, comprised of:
a cathode body having a surface portion formed of carbon fibers;
a polymer coating on said surface portion; and
carbon nanotubes embedded in said polymeric coating, substantially all of said nanotubes being longitudinally oriented in substantially the same direction.

2. An emission cathode as defined in claim 1, wherein said nanotubes are oriented in a direction generally perpendicular to said surface portion.

3. An emission cathode as defined in claim 1, wherein said polymer coating is formed of a thermosetting polymer.

4. An emission cathode as defined in claim 3, wherein said polymer is an epoxy or urethane.

5. An emission cathode as defined in claim 1, wherein said cathode body is cylindrical in shape.

6. An emission cathode as defined in claim 5, wherein said cathode body is comprised of a carbon fiber sheet rolled into a cylindrical shape.

7. An emission cathode as defined in claim 1, wherein said cathode body is comprised of a sheet of carbon fiber attached to a metal substrate.

8. An emission cathode as defined in claim 1, wherein said nanotubes are attached to a planar surface on said surface portion.

9. An emission cathode having a surface formed of carbon fiber and a layer of carbon nanotubes attached to said surface, said carbon nanotubes being generally parallel to each other and oriented longitudinally in a predetermined direction relative to said surface.

10. An emission cathode as defined in claim 9, wherein said carbon nanotubes are oriented perpendicularly to said surface.

11. An emission cathode as defined in claim 9, wherein said surface is formed of a carbon-fiber cloth.

12. An emission cathode as defined in claim 11, wherein said carbon fiber is formed into a cylindrical shape, and said carbon nanotubes are attached to a planar end surface of said cylindrical shape.

13. An emission cathode as defined in claim 11, wherein said carbon fiber cloth is a planar sheet attached to a metallic substrate.

14. An emission cathode as defined in claim 1, wherein said carbon nanotubes are attached to said surface by a polymer.

15. An emission cathode as defined in claim 14, wherein said polymer is a thermosetting polymer.

16. An emission cathode as defined in claim 15, wherein said thermosetting polymer is an epoxy or urethane.

17. A cathode having a body portion formed of carbon fibers, said body having a surface coated with a layer comprised of carbon nanotubes embedded in a polymer matrix, substantially all of said nanotubes being longitudinally aligned in substantially the same direction.

18. A cathode as defined in claim 17, wherein said body portion has a planar surface and said nanotubes are longitudinally aligned generally perpendicular to said planar surface.

19. A cathode as defined in claim 17, wherein said polymer matrix is comprised of a thermosetting polymer.

20. A cathode as defined in claim 19, wherein said polymer is an epoxy or urethane.

21. A cathode as defined in claim 17, wherein said body portion is cylindrical in shape.

22. A cathode as defined in claim 21, wherein said body portion is comprised of a carbon fiber cloth formed into a cylindrical shape.

23. A cathode as defined in claim 22, wherein said cylindrical shape is formed by rolling a sheet of carbon fiber cloth.

24. A cathode as defined in claim 23, wherein said cylindrical body portion has a planar end surface and said nanotubes are longitudinally aligned generally perpendicularly to said planar end surface.

25. A cathode as defined in claim 17, wherein said body portion has a flat, plate like configuration.

26. A cathode as defined in claim 25, wherein said body portion is comprised of a sheet of carbon fiber cloth attached to a planar metallic substrate, a surface of said carbon fiber cloth defining said surface that is coated.

27. A method of forming an explosive emission cathode, comprising the steps of:
forming a cathode body having a planar surface formed of carbon fibers;
coating said planar surface with a polymer;
adhering carbon nanotubes onto said polymer on said planar surface;
exposing said carbon nanotubes to an electric field to longitudinally align said nanotubes relative to said electric field; and
hardening said polymer.

28. A method as defined in claim 27, wherein said carbon nanotubes are aligned to be generally perpendicular to said planar surface.

29. A method as defined in claim 27, wherein said planar surface is comprised of carbon fiber cloth.

30. A method as defined in claim 29, wherein said planar surface is an end surface of a cylindrical roll of a sheet of carbon fiber cloth.

31. A method as defined in claim 29, wherein said carbon fiber cloth is a planar sheet attached to a metal substrate.

32. A method as defined in claim 27, wherein said polymer is a thermoset.

33. A method as defined in claim 32, wherein said polymer is an epoxy or urethane.

34. A method of forming an explosive emission cathode, comprising the steps of:
(a) applying carbon nanotubes onto a surface of a body formed of carbon fibers;
(b) longitudinally orienting said carbon nanotubes in a predetermined direction; and
(c) securing said oriented carbon nanotubes onto said surface of said carbon fiber body by means of a polymer.

35. A method as defined in claim 34, wherein said polymer is a thermoset.

36. A method as defined in claim 35, wherein said polymer is an epoxy or urethane.

37. A method as defined in claim 35, wherein said body is formed from a sheet of carbon fiber cloth.

38. A method as defined in claim 34, wherein said nanotubes are oriented to be generally perpendicular to said surface of said body.

39. A method as defined in claim 38, wherein said surface is a planar surface defined by a sheet of carbon fiber cloth.

40. A method as defined in claim 39, wherein said sheet of carbon fiber cloth is formed into a cylindrical shape and said planar surface is defined by one end of said cylindrical shape.

41. A method as defined in claim 39, wherein said planar surface is defined by a planar sheet of carbon fiber cloth, said carbon fiber cloth being supported on a metallic substrate.

42. A method of forming an emission cathode, comprising the steps of:
(a) forming a cathode body having a surface portion formed of carbon fibers; and
(b) securing a plurality of carbon nanotubes onto said surface portion, said nanotubes being essentially parallel to each other and aligned longitudinally in a predetermined direction.

43. A method as defined in claim 42, wherein said carbon nanotubes are secured to said surface portion by a polymer.

44. A method as defined in claim 42, wherein said cathode body is formed from a sheet of carbon fiber cloth.

45. A method as defined in claim 44, wherein said cathode body is formed by rolling said sheet of carbon fiber cloth into a cylindrical roll, and wherein said nanotubes are secured to a planar end surface of said cylindrical roll.

46. A method as defined in claim 42, wherein said nanotubes are oriented generally perpendicularly to said surface portion.
